(19) United States
(12) Patent Application Publication
(10) Pub. No.: US 2017/0090327 A1
(43) Pub. Date: Mar. 30, 2017

(54) IMAGE FORMING APPARATUS AND IMAGE FORMING METHOD

(71) Applicant: CASIO COMPUTER CO., LTD., Tokyo (JP)

(72) Inventors: Fumio SHIMAZU, Tokyo (JP); Yasunori HAGARI, Tokyo (JP); Hiroaki OTSUBO, Tokyo (JP); Hideki ANDO, Tokyo (JP)

(73) Assignee: CASIO COMPUTER CO., LTD., Tokyo (JP)

(21) Appl. No.: 15/195,512

(22) Filed: Jun. 28, 2016

(30) Foreign Application Priority Data
Sep. 24, 2015 (JP) 2015-186606

(51) Int. Cl. G03G 15/01

(52) U.S. Cl. CPC G03G 15/0131; G03G 15/1605

(57) ABSTRACT

An image forming apparatus including a binder pattern transfer section which transfers, at a first point, a binder pattern to a transfer belt moving in a predetermined direction, and a color pattern transfer section which transfers a color pattern to the transfer belt at predetermined timing, at a second point located on a lower flow side in a movement direction of the transfer belt than the first point, in which the color pattern transfer section applies electric charge to the binder pattern transferred by the binder pattern transfer section when the binder pattern passes through the second point along with a movement of the transfer belt, instead of transferring the color pattern to the transfer belt.

### CROSS-REFERENCE TO RELATED APPLICATION

This application is based upon and claims the benefit of priority from the prior Japanese Patent Application No. 2015-186606, filed Sep. 24, 2015, the entire contents of which are incorporated herein by reference.

### BACKGROUND OF THE INVENTION

1. Field of the Invention

The present invention relates to an image forming apparatus and an image forming method.

2. Description of the Related Art

Conventionally, in an electrophotographic image forming apparatus, a photosensitive drum in a developing device is generally initialized by being equally charged, a latent image is formed by optical writing on the photosensitive drum and developed to a toner image, and the toner image is directly or indirectly transferred to a print target medium and fixed thereto by a fixing device.

In the above-described image forming apparatus, wear printing using an electrophotographic technique is achieved by transferring an image, which has been formed with color toner on a transfer sheet, to a T-shirt or the like by thermocompression bonding. However, the color toner in this case desirably has a uniform particle diameter and has a good charging characteristic.

In order to make the image formed with the color toner stably adhere to a fabric such as the T-shirt, a binder is processed into a toner particle shape, transferred to the T-shirt together with the color toner, and interposed between the T-shirt and the color toner so as to firmly fuse the T-shirt and the color toner. In the case, in order to exhibit a function as the binder, a binder toner layer, which is significantly thicker than the color toner, needs to be formed. Accordingly, the binder toner is processed to have a particle diameter that is, for example, as large as 200 μm.

However, the binder toner actually processed has a particle diameter that is not uniform due to effects of a viscosity as the binder and a toner composition and covers a significantly wide range of 5 μm to 200 μm. Thus, the binder toner layer has a non-uniform thickness when formed by the transfer, and the binder toner has a poor charging characteristic in material quality, so that its charging amount is not stabilized. Therefore, the transfer cannot be stably performed.

Also, the surface of a transfer sheet (release sheet) to be used in the wear printing is subjected to special coating so that the whole thereof is transferred to the T-shirt, that is, subjected to processing for increasing surface unevenness that degrades the smoothness of the surface so that adhesion is degraded.

Accordingly, when the toner is secondarily transferred to the transfer sheet from a transfer belt, a thick air layer in a concave portion on the surface of the transfer sheet prevents electrostatic transfer. In such a case, even if development onto the photosensitive drum and primary transfer to the transfer belt from the photosensitive drum can be performed, it becomes significantly difficult to perform similar secondary transfer of the binder toner image to the secondary transfer of the color toner image on the transfer sheet.

In Japanese Patent Application Laid-Open (Kokai) Publication No. 2012-203178, for example, a technique has been proposed which provides a dedicated charger for adding a charging amount to a portion of a transfer belt just ahead of secondary transfer, increases a charging amount of toner on the transfer belt, and increases the thickness of a toner layer formed by the secondary transfer to a print target medium.

However, in Japanese Patent Application Laid-Open (Kokai) Publication No. 2012-203178, the dedicated charger for adding a charging amount needs to be separately provided. Therefore, in order to acquire a space in which the dedicated charger is loaded, the apparatus body become larger and leads to an increase in costs.

Note that, although the above-described problems have been described using the wear printing and the binder toner as an example, the present invention is not limited to the wear printing and the binder toner. Similar problems also have occurred for a case where toner particles having a weak charged particle characteristic (toner particles for special applications (transparency, white, light resistance/weather resistance/abrasion resistance, fluorescence, adhesion, a film, etc.) and toner particles having a large particle diameter) are charged.

### SUMMARY OF THE INVENTION

An object of the present invention is to stably transfer toner particles to a print target medium (transfer sheet) even if the toner particles have a weak charged particle characteristic.

In accordance with one aspect of the present invention, there is provided an image forming apparatus comprising: a binder pattern transfer section which transfers, at a first point, a binder pattern to a transfer belt moving in a predetermined direction; and a color pattern transfer section which transfers a color pattern to the transfer belt at predetermined timing, at a second point located on a lower flow side in a movement direction of the transfer belt than the first point, wherein the color pattern transfer section applies electric charge to the binder pattern transferred by the binder pattern transfer section when the binder pattern passes through the second point along with a movement of the transfer belt, instead of transferring the color pattern to the transfer belt.

In accordance with another aspect of the present invention, there is provided an image forming apparatus comprising: a first transfer section which transfers, at a first point, a binder pattern to a transfer belt moving in a predetermined direction; a second transfer section which transfers a first color pattern in a predetermined color to the transfer belt at first timing, at a second point located on a lower flow side in a movement direction of the transfer belt than the first point; and a third transfer section which transfers a second color pattern in a color different from the predetermined color to the transfer belt at second timing, at a third point located on a lower flow side in the movement direction of the transfer belt than the second point, wherein the second transfer section applies electric charge to the binder pattern transferred by the first transfer section when the binder pattern passes through the second point along with a movement of the transfer belt, instead of transferring the first color pattern to the transfer belt, and wherein the third transfer section applies electric charge to the binder pattern to which the electric charge has been applied by the second transfer section when the binder pattern passes through the third point along with the movement of the transfer belt, instead of transferring the second color pattern to the transfer belt.

In accordance with another aspect of the present invention, there is provided an image forming method comprising: a binder pattern transfer step of transferring, at a first point, a binder pattern to a transfer belt moving in a predetermined direction; a color pattern transfer step of transferring a color pattern to the transfer belt at predetermined timing, at a second point on a lower flow side in a movement direction of the transfer belt than the first point; and an electric charge application step of applying electric charge to the binder pattern transferred in the binder pattern transfer step when the binder pattern passes through the second point along with a movement of the transfer belt, instead of transferring the color pattern to the transfer belt.

According to the present invention, toner particles can be stably transferred to a transfer target medium (transfer sheet) even if the toner particles have a weak charged particle characteristic.

Advantages of the invention will be set forth in the description which follows, and in part will be obvious from the description, or may be learned by practice of the invention. The Advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a cross-sectional view showing the internal structure of an image forming apparatus 1 according to a first embodiment of the present invention;

FIG. 2 is a cross-sectional view showing the structure of and around an image forming unit 6 according to the first embodiment of the present invention;

FIG. 3 is a conceptual diagram showing a charging amount on an intermediate transfer belt 14 according to the first embodiment of the present invention;

FIG. 4 is a conceptual diagram for explaining the importance of positioning an image forming unit 6-1 for binder toner on the uppermost flow side with respect to image forming units 6-2 to 6-4 for color toner;

FIG. 5 is a flowchart for describing a wear printing operation of an image forming apparatus 1 according to the first embodiment of the present invention;

FIG. 6 is a conceptual diagram for describing the wear printing operation of the image forming apparatus 1 according to the first embodiment of the present invention;

FIG. 7 is also a conceptual diagram for describing the wear printing operation of the image forming apparatus 1 according to the first embodiment of the present invention;

FIG. 8 is a flowchart for describing a wear printing operation of an image forming apparatus 1 according to a second embodiment of the present invention;

FIG. 9 is a conceptual diagram for describing the wear printing operation of the image forming apparatus 1 according to the second embodiment of the present invention; and

FIG. 10 is a conceptual diagram for describing the structure and the operation of an image forming apparatus 1 according to a third embodiment of the present invention.

### DETAILED DESCRIPTION OF THE PREFERRED EMBODIMENTS

Embodiments of the present invention will hereinafter be described with reference to the drawings.

### First Embodiment

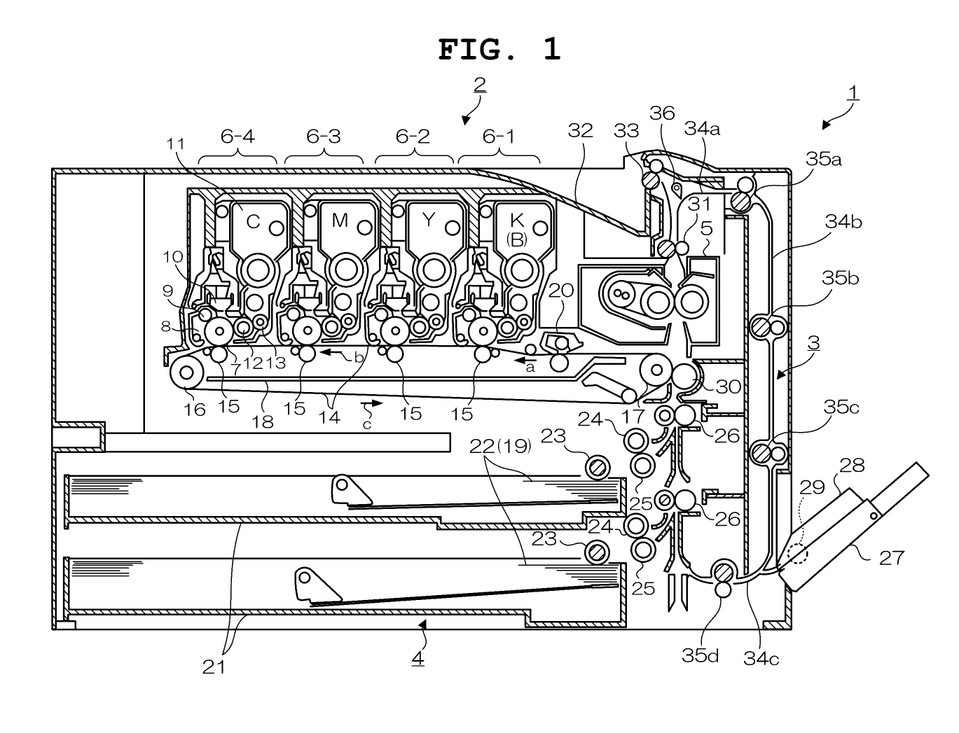

FIG. 1 is a cross-sectional view showing the internal structure of an image forming apparatus 1 according to a first embodiment of the present invention. The image forming apparatus 1 of the first embodiment in FIG. 1 has adopted a method of transferring toner images (a color pattern and a binder pattern) to an intermediate transfer belt and secondarily transferring the toner images (the color pattern and the binder pattern) to a sheet (a print target medium) such as a release sheet (transfer sheet) to be vertically conveyed to a secondary transfer section via the intermediate transfer belt.

This image forming apparatus 1 includes an image forming unit 2, a two-sided printing conveyance section 3, a sheet feeding section 4, and a fixing section 5. The image forming unit 2 has a structure where four image forming units (developing devices) 6 (6-1, 6-2, 6-3, and 6-4) have been provided side by side in multiple stages. The image forming unit 6-1 on the uppermost flow side forms a monochrome image in black (K). The three image forming units 6-2, 6-3, and 6-4 subsequent to the image forming unit 6-1 respectively form monochrome images with color toner in yellow (Y), magenta (M), and cyan (C) serving as the subtractive primary colors. The toner images in the four colors are overlaid on a sheet to form a full-color image.

Also, the image forming unit 6-1 is used to form a binder toner layer by replacing, when wear printing is performed, a toner cartridge in black (K) with a toner cartridge containing binder toner (B). Note that, in the first embodiment, a color image is transferred and fixed onto the sheet (transfer sheet), and then the binder toner layer is formed thereon.

The image forming units 6-1 to 6-4 respectively have the same structures except for the color and the type of the toner contained in the toner cartridge. Therefore, the structures will be described below using the structure of the image forming unit 6-4 as an example.

The image forming unit 6 has a photosensitive drum 7 in its lowermost portion. The peripheral surface of this photosensitive drum 7 is formed of, for example, an organic photoconductive material. A cleaner 8, a charging roller 9, an optical writing head 10, and a developing roller 12 in a developing device 11 are arranged to come in contact with or around the peripheral surface of the photosensitive drum 7.

The developing device 11 has in its upper portion a toner container containing the toner in any one of cyan (C), magenta (M), yellow (Y), and black (K), as indicated by C, M, Y, and K in FIG. 1, and has in its intermediate portion a toner replenishing mechanism oriented downward.

Also, the developing device 11 includes the above-described developing roller 12 in a lateral opening in its lower portion, and has in its inner portion a toner agitating member, a toner supply roller 13 for supplying toner to the developing roller 12, and a doctor blade for regulating a toner layer on the developing roller 12 to a predetermined layer thickness. The optical writing head 10 on the apparatus body side is arranged near the upper surface of the photosensitive drum 7 between the charging roller 9 and the developing device 11.

Also, an intermediate transfer belt 14 is arranged near the lower surface of the photosensitive drum 7. A primary transfer roller 15 is pressed toward the lower surface of the photosensitive drum 7 with this intermediate transfer belt 14 interposed therebetween.

The intermediate transfer belt 14 is an endless-shaped transfer belt constituted by a conductive sheet-like member made of resin containing conductive carbon or an ion conductive material and extending in a flat loop shape substantially from the left end to the right end in FIG. 1 at a substantially center portion of the apparatus body. This intermediate transfer belt 14 is stretched between a driving roller 16 and a driven roller 17, and cyclically driven in the counterclockwise direction in FIG. 1 by the driving roller 16 so as to cyclically move in the counterclockwise direction indicated by arrows a, b, and c in FIG. 1. Also, a belt cleaner 20 is arranged to come in contact with the surface of this intermediate transfer belt 14. This belt cleaner 20 removes waste toner from the top of the intermediate transfer belt 14.

The photosensitive drum 7 rotates in the clockwise direction in FIG. 1. First, the peripheral surface of the photosensitive drum 7 is initialized by being equally charged by electric charge from the charging roller 9. Then, an electrostatic latent image is formed on the peripheral surface of the photosensitive drum 7 by optical writing from the optical writing head 10 based on printing information.

This electrostatic latent image is developed to a toner image using the toner contained in the developing device 11 by development processing using the developing roller 12. The toner image, which has been developed on the peripheral surface of the photosensitive drum 7, is directly transferred (primarily transferred) to the belt surface of the intermediate transfer belt 14 by the primary transfer roller 15 along with the rotation of the photosensitive drum 7.

More specifically, the photosensitive drum 7 and the primary transfer roller 15 are structured as a part of a color pattern transfer section for transferring a color pattern (a color toner image) to a belt surface of the intermediate transfer belt 14 or a part of a binder pattern transfer section for transferring a binder pattern (a binder toner image) to the belt surface of the intermediate transfer belt 14.

Note that the intermediate transfer belt 14 conveys the toner image, which has been directly transferred (primarily transferred) to the belt surface, to a transfer position for the sheet 22 to further transfer (secondarily transfer) the toner image to the sheet 22.

A belt position control mechanism 18 in FIG. 1 includes primary transfer rollers 15, each of which is constituted by a conductive foamed sponge that is pressed against the lower circumferential surface of the photosensitive drum 7 via the intermediate transfer belt 14. This belt position control mechanism 18 rotationally moves the three primary transfer rollers 15 respectively corresponding to the three image forming units 6-4, 6-3, and 6-2 for cyan (C), magenta (M), and yellow (Y) in the same period with hook-type support shafts as their centers. Then, the belt position control mechanism 18 rotationally moves one primary transfer roller 15 corresponding to the image forming unit 6-1 in black (K) in a rotational movement period different from that of the three primary transfer rollers 15, so that the intermediate transfer belt 14 comes in contact with or separates from the photosensitive drum 7.

More specifically, the belt position control mechanism 18 switches the position of the intermediate transfer belt 14 to a position for a full-color mode (all the four primary transfer rollers 15 come in contact with the intermediate transfer belt 14), a position for a monochrome mode (only the primary transfer roller 15 corresponding to the image forming unit 6-1 comes in contact with the intermediate transfer belt 14), and a position for a non-transfer mode (all the four primary transfer rollers 15 separate from the intermediate transfer belt 14). Also, in wear printing, only the primary transfer roller 15 corresponding to the image forming unit 6-1 comes in contact with the intermediate transfer belt 14 as in the case of the above-described monochrome mode, even when primarily transferring the binder toner (B).

The sheet feeding section 4 includes two sheet cassettes 21 arranged in two upper and lower stages, and a large number of cut sheets 22 are stored in either one or both of the sheet cassettes 21 in the sheet feeding section 4. Note that in wear printing, the sheet 22 may be replaced with a transfer sheet (or release sheet) 19. A paper extraction roller 23, a feed roller 24, a separation roller 25, and a standby conveyance roller pair 26 are arranged near each of the sheet feed ports (on the right side in FIG. 1) of these two sheet cassettes 21.

The sheets 22 are conveyed from the sheet cassette 21 one by one by the rotation of the paper extraction roller 23, and fed to the standby conveyance roller pair 26 via the feed roller 24 and the separation roller 25. Alternatively, when the sheet 22 has an unusual thickness or size, the sheet 22 (or the transfer sheet 19) is fed to the standby conveyance roller pair 26 via a sheet feeding roller 29 from above an MPF (Multi Paper Feeder) tray 28 mounted on an opened mounting section 27.

In the paper conveyance direction (in the vertically upward direction in FIG. 1) of the standby conveyance roller pair 26, a secondary transfer roller 30, which comes in pressure contact with the driven roller 17 via the intermediate transfer belt 14, is arranged. The intermediate transfer belt 14, the driven roller 17, and the secondary transfer roller 30 form a secondary transfer section for the sheet 22 (or transfer sheet 19).

The fixing section 5 including a belt-type thermal fixing unit is arranged on the lower flow side (on the upper side in FIG. 1) of this secondary transfer section. On the further lower flow side of the fixing section 5, a conveyance roller pair 31 which conveys the sheet 22 (or the transfer sheet 19) after fixing from the fixing section 5, and a paper ejection roller pair 33 which ejects the conveyed sheet 22 to a paper ejection tray 32 formed on the upper surface of the apparatus are arranged.

The two-sided printing conveyance unit 3 includes a return path (a corridor loop path) branched in the right lateral direction in FIG. 1 from a conveyance path in an intermediate portion between the conveyance roller pair 31 and the paper ejection roller pair 33. This return path includes a start return path 34a, an intermediate return path 34b bent downward, an end return path 34c bent in the left lateral direction for conclusively reversing returned paper, and four return roller pairs 35a, 35b, 35c, and 35d arranged halfway in the return paths. An outlet of the end return path 34c connects to a conveyance path directed toward the standby conveyance roller pair 26 corresponding to the sheet cassette 21 in a lower portion of the sheet feeding section 4.

Also, the two-sided printing conveyance unit 3 is used to not only perform two-sided printing but also perform multiple printing on the respective same surfaces of the sheets 22 (or the transfer sheets 19). Particularly, in the present embodiment, in wear printing, the sheet 22 (or the transfer sheet 19) color-printed in cyan (C), magenta (M), and yellow (Y) is first returned to the secondary transfer section (the driven roller 17 and the secondary transfer roller 30) again via the return path in the two-sided printing conveyance unit 3. Therefore, a route change flapper 36 is arranged near an inlet of the return path branched in the right lateral direction in FIG. 1 from the conveyance path in the intermediate portion between the conveyance roller pair 31 and the paper ejection roller pair 33. The route change flapper 36 is driven leftward or rightward in FIG. 1 near the inlet of the return path so as to sort the transfer sheets 19 conveyed from the fixing section 5 depending on whether the transfer sheet 19 is directly ejected, is conveyed in a paper ejection direction toward the paper ejection tray 32 to change a print surface, or is fed into the return path to repeatedly perform printing.

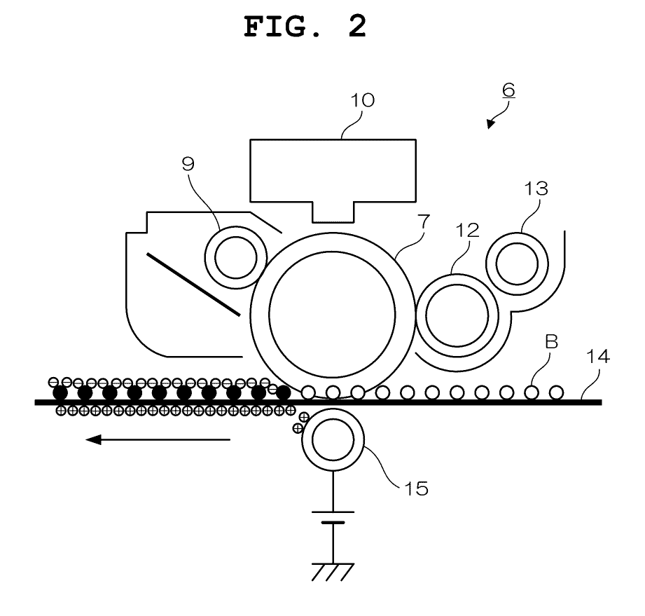

FIG. 2 is a cross-sectional view showing the structure of and near the image forming unit 6 according to the first embodiment. Note that sections corresponding to those shown in FIG. 1 are provided with the same reference numerals, and therefore descriptions thereof are not omitted. The image forming unit 6 shown in FIG. 2 corresponds to the image forming units 6-1 to 6-4 shown in FIG. 1. In the first embodiment, in order to enable particles having a weak charged particle characteristic, such as the binder toner (B), to be efficiently image-formed on a transfer sheet in wear printing, when a binder layer is formed with the binder toner (B) (when a binder pattern is formed), a high positive potential (a positive potential having a value larger than a value of a positive potential applied from the primary transfer roller 15 when the toner contained in the image forming units 6-2 to 6-4 is primarily transferred to the intermediate transfer belt 14) is applied to the rear surface of the intermediate transfer belt 14 from the primary transfer roller 15 in the image forming units 6-2 to 6-4 on the lower flow side (positive charging processing) so as to add a charging amount to the binder toner (B) serving as the binder pattern (counter charging). The binder toner (B), which has been primarily transferred as the binder pattern to the intermediate transfer belt 14, is charged to a negative potential. Therefore, every time the binder toner (B) passes through the image forming units 6-2 to 6-4, the primary transfer roller 15, to which a positive potential has been applied, can gradually charge the binder toner (B) more greatly.

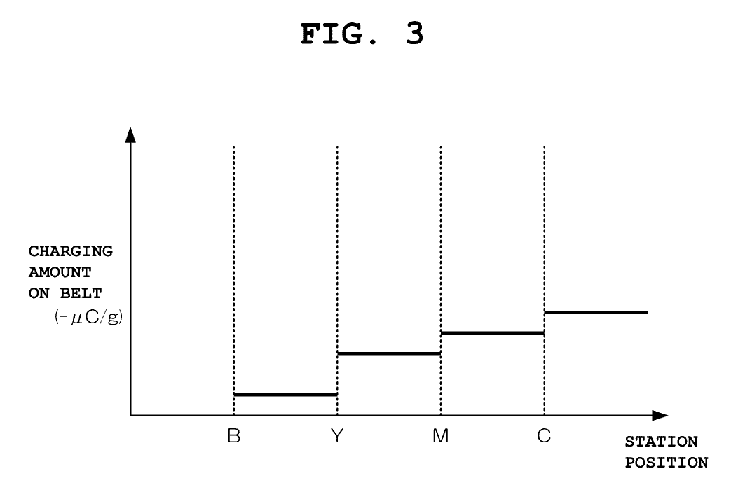

FIG. 3 is a conceptual diagram showing a charging amount on the intermediate transfer belt 14 according to the first embodiment. In the first embodiment, the image forming unit 6-1 for the binder toner (B) is arranged on the uppermost flow side, and a high positive potential is applied to the rear surface of the intermediate transfer belt 14 from the primary transfer rollers 15 respectively corresponding to the image forming units 6-2 to 6-4 for the color toner excluding the image forming unit 6-1 for the binder toner (B) when the binder layer is formed with the binder toner (B). As a result, when the image forming units 6-2 to 6-4 in yellow (Y), cyan (C), and magenta (M) are on the lower flow side as shown in FIG. 3, counter charging is repeated a total of three times, so that the charging amount on the intermediate transfer belt 14 gradually increases and sufficient charging can be obtained.

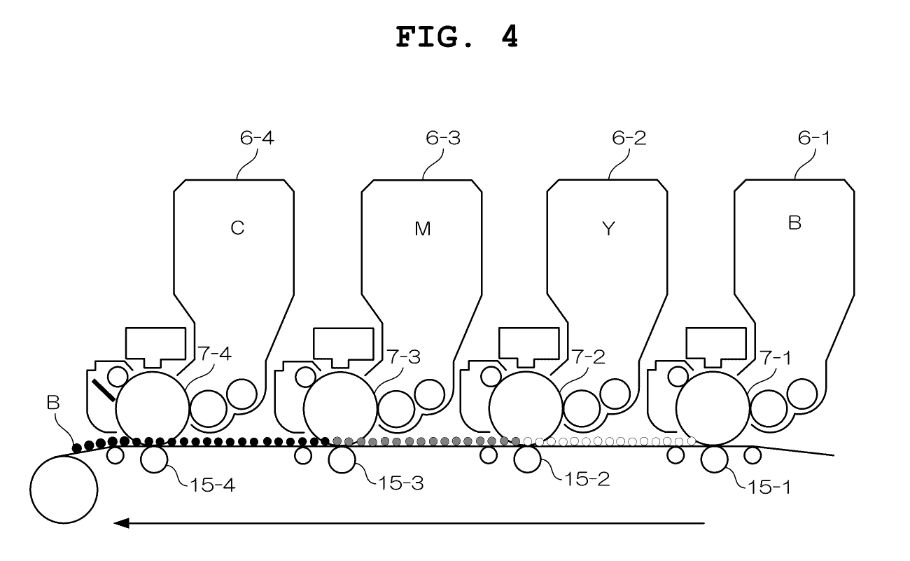

FIG. 4 is a conceptual diagram showing the importance of positioning the image forming unit 6-1 for the binder toner (B) on the uppermost flow side with respect to the image forming units 6-2 to 6-4 for the color toner as shown in FIG. 3. The binder toner (B) is weak in the charging amount even if it is placed on the intermediate transfer belt 14 by primary transfer. Because the charging amount is weak, a retaining state on the intermediate transfer belt 14 may become unstable. Accordingly, when the binder toner (B), which has been primarily transferred as the binder pattern to the intermediate transfer belt 14, is fed to an area below the image forming units 6-2 to 6-4 for the color toner on the lower flow side, counter charge is applied to the binder toner (B) on the intermediate transfer belt 14 by a transfer current between photosensitive drums 7-2 to 7-4 and the primary transfer rollers 15 (15-2 to 15-4) for the image forming units 6-2 to 6-4 so as to gradually supplement (add) the charging amount.

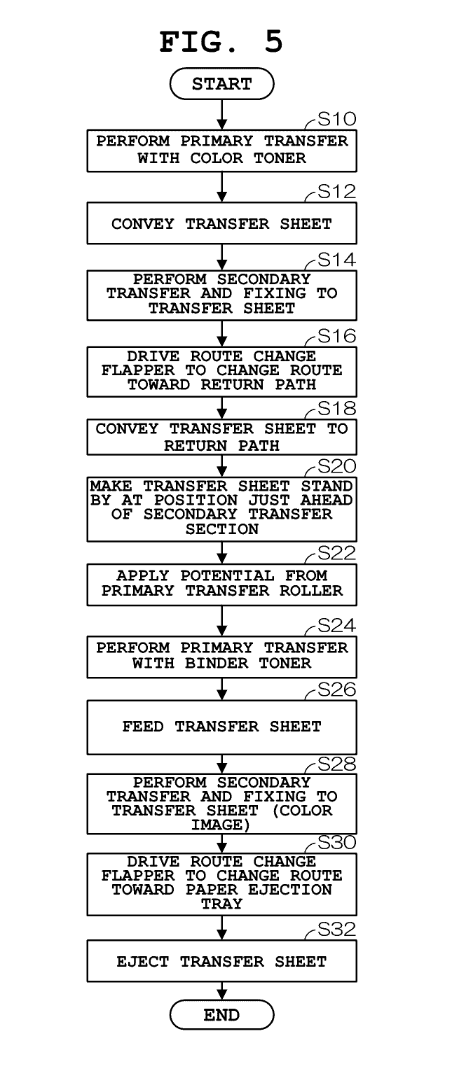

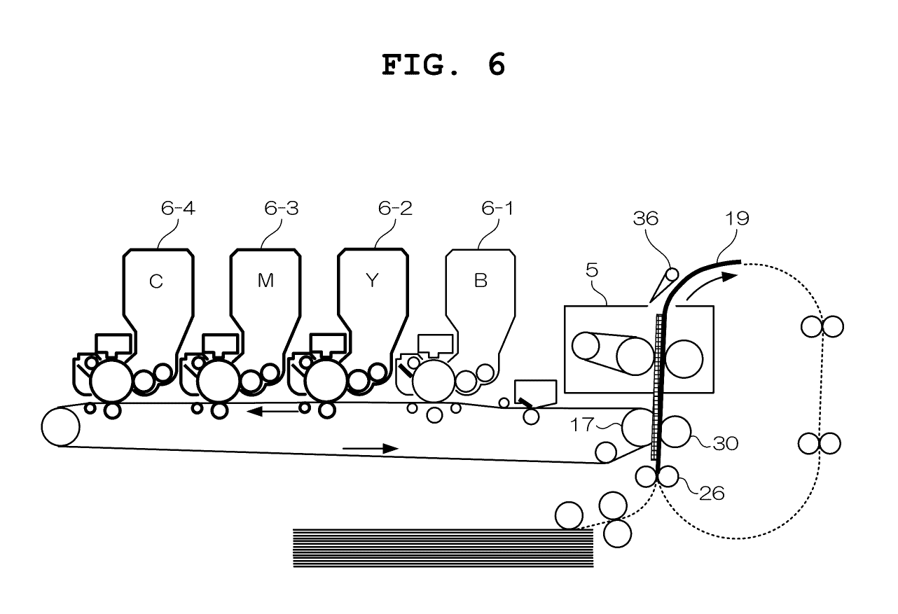

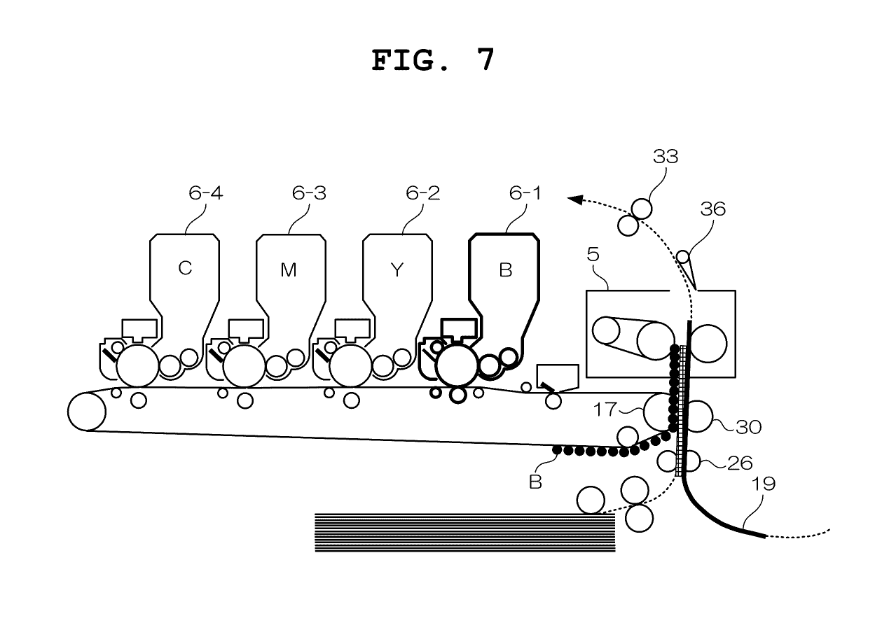

FIG. 5 is a flowchart for describing a wear printing operation of the image forming apparatus 1 according to the first embodiment. FIG. 6 and FIG. 7 are conceptual diagrams for describing the wear printing operation of the image forming apparatus 1 according to the first embodiment.

First, the image forming apparatus 1 primarily transfers an image using color toner (a color pattern) to the intermediate transfer belt 14 (Step S10). More specifically, in the image forming units 6-2 to 6-4, the photosensitive drum 7 is charged by the charging roller 9, a latent image is formed by the optical writing head 10, the color toner is developed on the photosensitive drum 7, and a toner image is transferred to the intermediate transfer belt 14 as a color pattern by the primary transfer roller 15.

On the other hand, the image forming apparatus 1 conveys the transfer sheet 19 by the rotation of the paper extraction roller 23 from the sheet cassette 21, and feeds the transfer sheet 19 to the standby conveyance roller pair 26 via the feed roller 24 and the separation roller 25 so as to make the transfer sheet 19 stand by (Step S12). Then, the image forming apparatus 1 feeds the transfer sheet 19 which has been made to stand by at a position of the standby conveyance roller pair 26 into the secondary transfer section (the driven roller 17 and the secondary transfer roller 30) in a manner to coincide with timing at which the toner image (color pattern) transferred to the intermediate transfer belt 14 reaches the secondary transfer section, secondarily transfers the color image (color pattern) to the transfer sheet 19, and then causes the fixing section 5 to fix the color image (Step S14). After the transfer, the belt cleaner 20 cleans the intermediate transfer belt 14.

Then, the image forming apparatus 1 drives the route change flapper 36 to change a route toward the return path (Step S16), and conveys the transfer sheet 19 where the color image (color pattern) has been fixed to the return path (Step S18), as shown in FIG. 6. Then, the image forming apparatus 1 feeds the transfer sheet 19 conveyed to the return path to the standby conveyance roller pair 26 via the start return path 34a, the intermediate return path 34b, and the end return path 34c, and makes the transfer sheet 19 stand by (Step S20).

On the other hand, the image forming apparatus 1 applies a high positive potential to the rear surface of the intermediate transfer belt 14 from the primary transfer rollers 15 respectively corresponding to the image forming units 6-2 to 6-4 for the color toner excluding the image forming unit 6-1 for the binder toner (B) (Step S22). Then, the image forming apparatus 1 primarily transfers the binder layer using the binder toner (B) to the intermediate transfer belt 14 (Step S24). More specifically, in the image forming unit 6-1, the photosensitive drum 7 is charged by the charging roller 9, a latent image is formed by the optical writing head 10, the binder toner (B) is developed on the photosensitive drum 7, and a toner image (binder pattern) using the binder toner (B) is transferred to the intermediate transfer belt 14 by the primary transfer roller 15.

Here, when the binder toner (B) primarily transferred to the intermediate transfer belt 14 is fed to each of the image forming units 6-2 to 6-4 for the color toner on the lower flow side, counter charge is applied to the binder toner (B) on the intermediate transfer belt 14 by a transfer current between the photosensitive drums 7-2 to 7-4 and the primary transfer rollers 15 (15-2 to 15-4) for the image forming units 6-2 to 6-4, as shown in FIG. 4, so that the charging amount is gradually supplemented (added). As a result of this counter charging performed three times, the binder toner (B) on the intermediate transfer belt 14 is sufficiently greatly charged. Therefore, the binder toner (B) can be made to adhere to the intermediate transfer belt 14 more stably.

More specifically, each of the image forming units 6-2 to 6-4 for the color toner applies electric charge to the binder pattern primarily transferred to the intermediate transfer belt 14 when the binder pattern is fed thereto, instead of transferring the color pattern to the intermediate transfer belt 14.

Then, the image forming apparatus 1 feeds the transfer sheet 19, which has been made to stand by at the position of the standby conveyance roller pair 26 and to which the color image (color pattern) has already been fixed, to the secondary transfer section in a manner to coincide with timing at which the toner image (binder pattern) using the binder toner (B) transferred to the intermediate transfer belt 14 reaches the secondary transfer section (the driven roller 17 and the secondary transfer roller 30) (Step S26), secondarily transfers the binder toner (B) to a surface of the transfer sheet 19 to which the color image (color pattern) has been fixed, and then causes the fixing section 5 to fix the binder toner (B) (Step S28), as shown in FIG. 7. After the transfer, the belt cleaner 20 cleans the intermediate transfer belt 14. As a result, one cycle of image forming processes in the wear printing is ended.

Then, the image forming apparatus 1 drives the route change flapper 36 to change a route toward the paper ejection tray 32 (Step S30), and ejects the transfer sheet 19, on which respective layers with the color image (color pattern) and the binder toner (binder pattern) have been formed and which are conveyed from the fixing section 5, to the paper ejection tray 32 (Step S32).

According to the above-described first embodiment, the counter charge is applied to the binder toner (B) on the intermediate transfer belt 14 in the image forming units 6-2 to 6-4 on the lower flow side. Therefore, toner particles having a weak charged particle characteristic can be stably transferred to the transfer sheet 19 with a sufficient layer thickness.

### Second Embodiment

Next, a second embodiment of the present invention is described.

In the above-described first embodiment, the color image is first transferred and fixed to the transfer sheet 19, the transfer sheet 19 is then returned to a position just ahead of the secondary transfer section via the return path, and the binder toner (B) on the intermediate transfer belt 14 is transferred and fixed while the counter charge is being applied thereto in the image forming units 6-2 to 6-4 on the lower flow side.

In the second embodiment, when a charging characteristic is not sufficient from a time point of development and a predetermined adhesion amount is not acquired, the binder toner (B) is, as a binder pattern, repeatedly transferred and fixed by a plurality of times on a transfer sheet 19 to which a color image (color pattern) has been transferred and fixed, so that a predetermined adhesion amount is ensured on the transfer sheet 19.

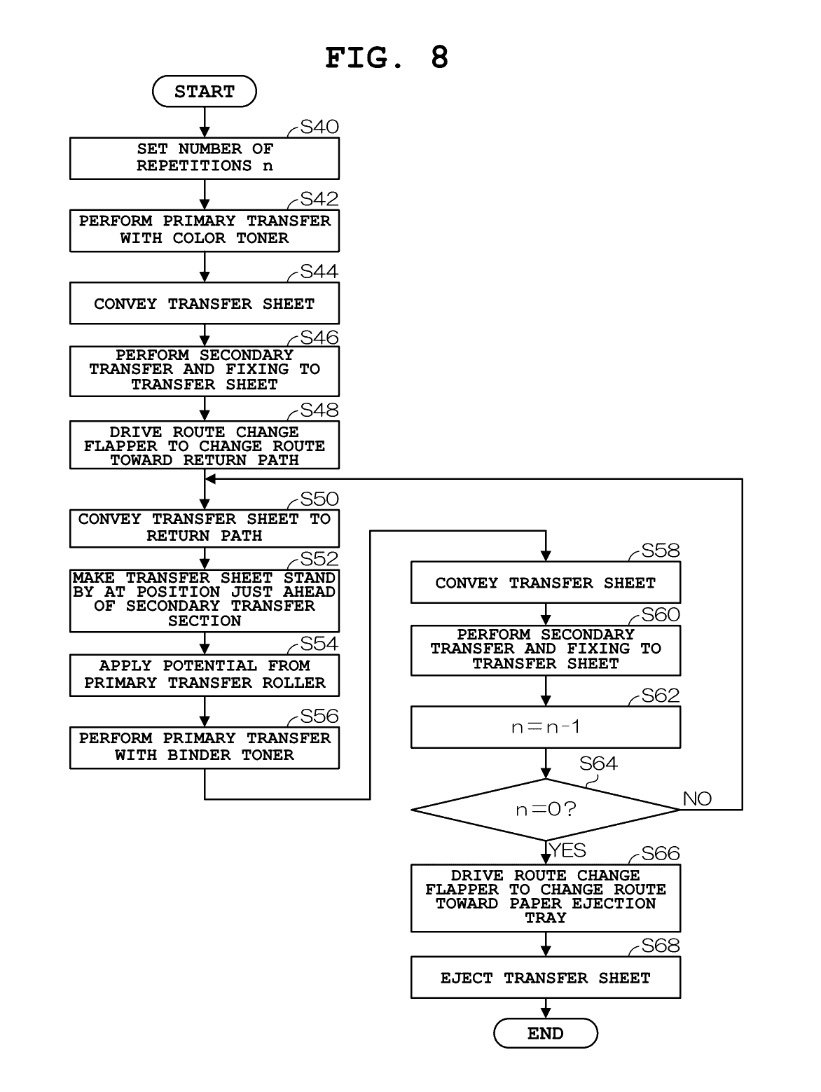

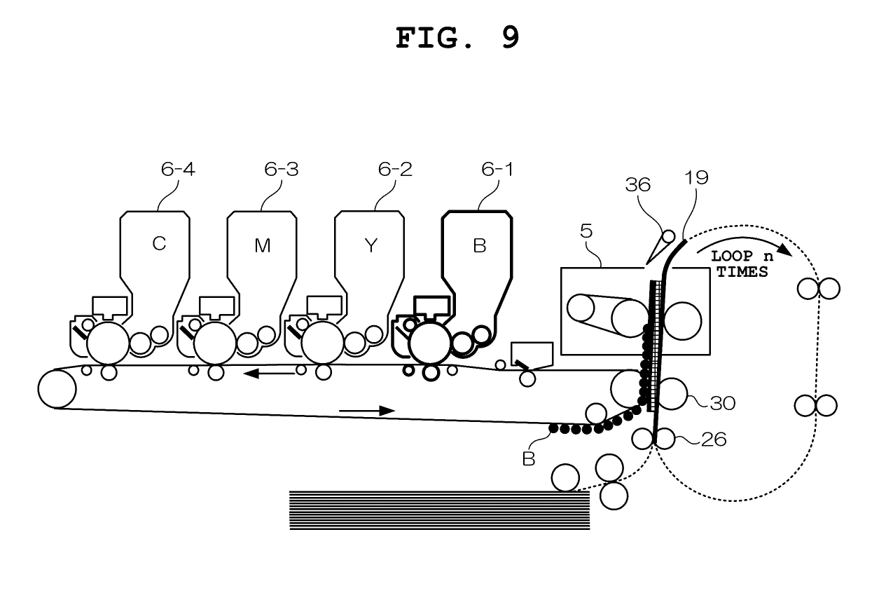

FIG. 8 is a flowchart for describing a wear printing operation of an image forming apparatus 1 according to the second embodiment. FIG. 9 is a conceptual diagram for describing the wear printing operation of the image forming apparatus 1 according to the second embodiment.

First, the image forming apparatus 1 sets the number of repetitions n (e.g., two times, three times, etc.) of secondary transfer and fixing of the binder toner (B) (Step S40). Note that the number of repetitions n may be previously set, designated every time by a user, or automatically set depending on the type of the binder toner (B) and the temperature and humidity at that time. Then, the image forming apparatus 1 primarily transfers an image using color toner to the intermediate transfer belt 14 (Step S42). More specifically, in the image forming units 6-2 to 6-4, the photosensitive drum 7 is charged by the charging roller 9, a latent image is formed by the optical writing head 10, the color toner is developed on the photosensitive drum 7, and a toner image is transferred to the intermediate transfer belt 14 by the primary transfer roller 15.

On the other hand, the image forming apparatus 1 conveys the transfer sheet 19 by the rotation of the paper extraction roller 23 from the sheet cassette 21, and feeds the transfer sheet 19 to the standby conveyance roller pair 26 via the feed roller 24 and the separation roller 25 so as to make the transfer sheet 19 stand by (Step S44). Then, the image forming apparatus 1 feeds the transfer sheet 19 which has been made to stand by at a position of the standby conveyance roller pair 26 into the secondary transfer section (the driven roller 17 and the secondary transfer roller 30) in a manner to coincide with timing at which the toner image transferred to the intermediate transfer belt 14 reaches the secondary transfer section, secondarily transfers the color image to the transfer sheet 19, and then causes the fixing section 5 to fix the color image (Step S46). After the transfer, the belt cleaner 20 cleans the intermediate transfer belt 14.

Then, the image forming apparatus 1 drives the route change flapper 36 to change a route toward the return path (Step S48), and conveys the transfer sheet 19 where the color image has been fixed to the return path (Step S50), as shown in FIG. 9. Then, the image forming apparatus 1 feeds the transfer sheet 19 conveyed to the return path to the standby conveyance roller pair 26 via the start return path 34a, the intermediate return path 34b, and the end return path 34c, and makes the transfer sheet 19 stand by (Step S52).

On the other hand, the image forming apparatus 1 applies a high positive potential to the rear surface of the intermediate transfer belt 14 from the primary transfer rollers 15 respectively corresponding to the image forming units 6-2 to 6-4 for the color toner excluding the image forming unit 6-1 for the binder toner (B) (Step S54). Then, the image forming apparatus 1 primarily transfers the binder layer using the binder toner (B) to the intermediate transfer belt 14 (Step S56). More specifically, in the image forming unit 6-1, the photosensitive drum 7 is charged by the charging roller 9, a latent image is formed by the optical writing head 10, the binder toner (B) is developed on the photosensitive drum 7, and a toner image using the binder toner (B) is transferred to the intermediate transfer belt 14 by the primary transfer roller 15.

Here, when the binder toner (B) primarily transferred to the intermediate transfer belt 14 is fed to each of the image forming units 6-2 to 6-4 for the color toner on the lower flow side, counter charge is applied to the binder toner (B) on the intermediate transfer belt 14 by a transfer current between the photosensitive drums 7-2 to 7-4 and the primary transfer rollers 15 (15-2 to 15-4) for the image forming units 6-2 to 6-4, as shown in FIG. 4, so that the charging amount is gradually supplemented (added). As a result of this counter charging performed three times, the binder toner (B) on the intermediate transfer belt 14 is sufficiently greatly charged. Therefore, the binder toner (B) can be made to adhere to the intermediate transfer belt 14 more stably.

Then, the image forming apparatus 1 feeds the transfer sheet 19, which has been made to stand by at the position of the standby conveyance roller pair 26 and to which the color image has already been fixed, to the secondary transfer section (the driven roller 17 and the secondary transfer roller 30) in a manner to coincide with timing at which the toner image using the binder toner (B) transferred to the intermediate transfer belt 14 reaches the secondary transfer section (Step S58), secondarily transfers the binder toner (B) to a surface of the transfer sheet 19 to which the color image has been fixed, and then causes the fixing section 5 to fix the binder toner (B) (Step S60). After the transfer, the belt cleaner 20 cleans the intermediate transfer belt 14. As a result, one cycle of image forming processes in the wear printing is ended.

Then, the image forming apparatus 1 decrements the number of repetitions n by one (Step S62), and judges whether the number of repetitions n has reached zero, that is, whether the secondary transfer and fixing of the binder toner (B) has been performed by the number of times of repetitions n (Step S64). When judged that the number of repetitions n has not reached zero (NO in Step S64), the processing returns to Step S50. At Step S50, the image forming apparatus 1 repeats the above-described operation. More specifically, the transfer sheet 19 where respective layers with the color image and the binder toner (B) have been fixed is conveyed to the return path with the route change flapper 36 being directed toward the return path, and the application of a counter charge to the binder toner (B) and the secondary transfer and fixing of the binder toner (B) are performed by the number of times of repetitions n again, as shown in FIG. 9. As a result of this configuration where the binder toner (B), which does not easily adhere to the transfer sheet 19, is repeatedly fixed to the transfer sheet 19, a binder toner (B) having a desired layer thickness can be more stably stacked thereon.

When judged that the number of repetitions n has reached zero (YES in Step S64), the image forming apparatus 1 drives the route change flapper 36 to change a route toward the paper ejection tray 32 (Step S66), and ejects the transfer sheet 19, on which the respective layers with the color image and the binder toner have been formed and which are conveyed from the fixing section 5, to the paper ejection tray 32 (Step S68).

According to the above-described second embodiment, the color image is transferred and fixed to the transfer sheet 19, the transfer sheet 19 is returned to a position just ahead of the secondary transfer section via the return path, and the binder toner (B) on the intermediate transfer belt 14 is secondarily transferred and fixed a plurality of times using the return path a number of times while the counter charge is being applied to the binder toner (B) in the image forming units 6-2 to 6-4 on the lower flow side. Therefore, toner particles having a weak charged particle characteristic can be stably transferred to the transfer sheet 19 with a sufficient layer thickness.

### Third Embodiment

Next, a third embodiment is described.

In the third embodiment, the position of the image forming unit 6 for the binder toner (B) can be freely selected based on the premise that the binder toner (B) is secondarily transferred and fixed a plurality of times using the return path a number of times without counter charging being performed.

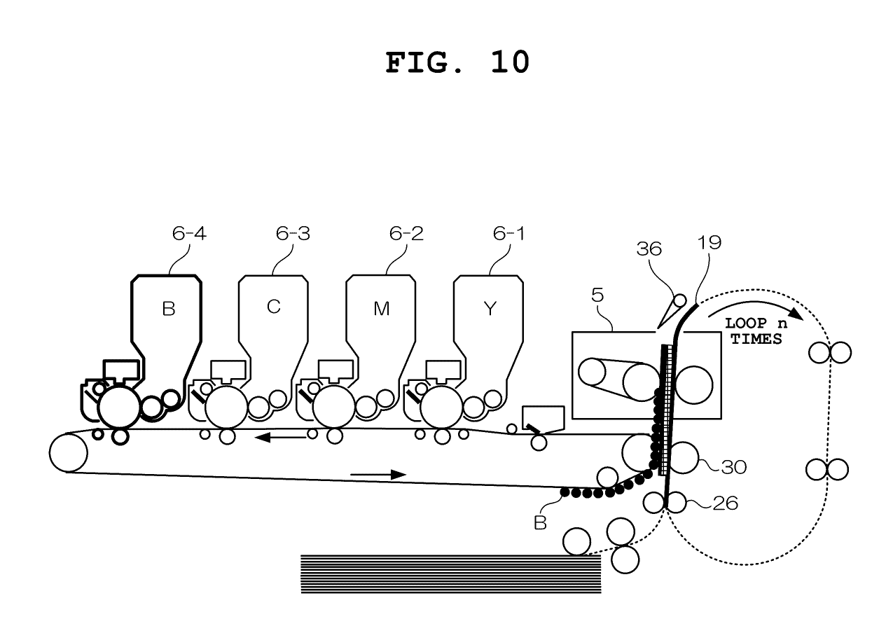

FIG. 10 is a conceptual diagram for describing the structure and the operation of an image forming apparatus 1 according to the third embodiment. As described above, in the method for acquiring a predetermined adhesion amount or more on a transfer target material, if the secondary transfer and fixing of the binder toner (B) to the same surface of the transfer sheet 19 are ensured to be performed a plurality of times, the counter charging is not required to be performed, whereby the position of the image forming unit 6 for the binder toner (B) is not required to be fixed to the uppermost flow side. Therefore, in the third embodiment, the image forming units 6-1 to 6-3 on the upper flow side are respectively used for color toners (Y), (M), and (C), and the image forming unit 6-4 on the lower flow side is used for the binder toner (B), as shown in FIG. 10.

In such a structure, the image forming apparatus 1 performs secondary transfer and fixing a plurality of times using the return path a number of times without performing counter charging. More specifically, the image forming units 6-1 to 6-3 perform the primary transfer of a color image and the secondary transfer and fixing of the color image to the transfer sheet 19 in the first cycle, and then the image forming unit 6-4 repeats primary the transfer of the binder toner (B) and the secondary transfer and fixing of the binder toner (B) to the transfer sheet 19 n times while looping the transfer sheet 19 via the return path n times in the second and subsequent cycles.

According to the above-described third embodiment, the binder toner (B) is repeatedly transferred and fixed a plurality of times. As a result of this structure, toner particles having a weak charged particle characteristic can be stably transferred to the transfer sheet 19 with a sufficient layer thickness.

Note that, even when counter charging is not performed as in the case of the above-described third embodiment, if the image forming unit 6-1 on the uppermost flow side is used for the binder toner (B) as in the case of the above-described first and second embodiments, the color toner and the binder toner (CMYB) can be transferred and fixed in the first cycle. Therefore, the number of repetitions n can be reduced by one. More specifically, in the above-described third embodiment as well, the image forming unit 6-1 on the uppermost flow side may be used for the binder toner (B), and secondary transfer and fixing may be performed a plurality of times using the return path a number of times without counter charging being performed.

According to the above-described first to third embodiments, the transfer sheet 19 is returned to the position just ahead of the secondary transfer section via the return path. Therefore, the binder toner (B) can be repeatedly transferred and fixed a plurality of times using an existing apparatus structure.

Also, according to the above-described first to third embodiments, the transfer sheet 19 is returned to the position just ahead of the secondary transfer section via the return path by the route change flapper 36. Therefore, the binder toner (B) can be repeatedly transferred and fixed in a simple structure.

Note that, although a contact mono-component developing device has been taken as the developing device 11 in the above-described first to third embodiments, a magnetic brush two-component developing device may be similarly used.

While the present invention has been described with reference to the preferred embodiments, it is intended that the invention be not limited by any of the details of the description therein but includes all the embodiments which fall within the scope of the appended claims.

What is claimed is:

1. An image forming apparatus comprising:
a binder pattern transfer section which transfers, at a first point, a binder pattern to a transfer belt moving in a predetermined direction; and
a color pattern transfer section which transfers a color pattern to the transfer belt at predetermined timing, at a second point located on a lower flow side in a movement direction of the transfer belt than the first point,
wherein the color pattern transfer section applies electric charge to the binder pattern transferred by the binder pattern transfer section when the binder pattern passes through the second point along with a movement of the transfer belt, instead of transferring the color pattern to the transfer belt.

2. The image forming apparatus according to claim 1, wherein the color pattern transfer section applies a potential having a polarity opposite to a polarity of a potential charged to the binder pattern to a surface on an opposite side of a surface of the transfer belt where the binder pattern has been transferred, and thereby additionally applies electric charge to the binder pattern.

3. The image forming apparatus according to claim 2, wherein the color pattern transfer section additionally applies the electric charge to the binder pattern via a roller which presses the surface on the opposite side of the surface of the transfer belt where the binder pattern has been transferred.

4. The image forming apparatus according to claim 3, wherein the roller is provided at a position opposing a photoreceptor via the transfer belt.

5. The image forming apparatus according to claim 2, wherein the color pattern transfer section applies, when additionally applying the electric charge to the binder pattern, a potential higher than the potential that is applied when the color pattern is transferred to the transfer belt.

6. The image forming apparatus according to claim 1, further comprising:
a secondary transfer section which secondarily transfers the color pattern transferred to the transfer belt by the color pattern transfer section to a release sheet while secondarily transferring the binder pattern to which the electric charge has been applied by the color pattern transfer section to the secondarily transferred color pattern.

7. The image forming apparatus according to claim 6, wherein a conveyance path is provided for retracting the release sheet to which the color pattern has been secondarily transferred by the secondary transfer section to a predetermined retracting position when the binder pattern transfer section transfers the binder pattern to the transfer belt.

8. An image forming apparatus comprising:
a first transfer section which transfers, at a first point, a binder pattern to a transfer belt moving in a predetermined direction;
a second transfer section which transfers a first color pattern in a predetermined color to the transfer belt at first timing, at a second point located on a lower flow side in a movement direction of the transfer belt than the first point; and
a third transfer section which transfers a second color pattern in a color different from the predetermined color to the transfer belt at second timing, at a third point located on a lower flow side in the movement direction of the transfer belt than the second point,
wherein the second transfer section applies electric charge to the binder pattern transferred by the first transfer section when the binder pattern passes through the second point along with a movement of the transfer belt, instead of transferring the first color pattern to the transfer belt, and
wherein the third transfer section applies electric charge to the binder pattern to which the electric charge has been applied by the second transfer section when the binder pattern passes through the third point along with the movement of the transfer belt, instead of transferring the second color pattern to the transfer belt.

9. The image forming apparatus according to claim 8, wherein the second transfer section transfers a color pattern in yellow, and
wherein the third transfer section transfers a color pattern in magenta or cyan.

10. The image forming apparatus according to claim 8, wherein the third transfer section transfers a color pattern in cyan, and
wherein the second transfer section transfers a color pattern in yellow or magenta.

11. The image forming apparatus according to claim 8, wherein the second transfer section and the third transfer section apply a potential having a polarity opposite to a polarity of a potential charged to the binder pattern to a surface on an opposite side of a surface of the transfer belt where the binder pattern has been transferred, and thereby additionally apply electric charge to the binder pattern.

12. The image forming apparatus according to claim 11, wherein the second transfer section and the third transfer section additionally apply the electric charge to the binder pattern via a roller which presses the surface on the side opposite to the surface of the transfer belt where the binder pattern has been transferred.

13. An image forming method comprising:
a binder pattern transfer step of transferring, at a first point, a binder pattern to a transfer belt moving in a predetermined direction;
a color pattern transfer step of transferring a color pattern to the transfer belt at predetermined timing, at a second point on a lower flow side in a movement direction of the transfer belt than the first point; and
an electric charge application step of applying electric charge to the binder pattern transferred in the binder pattern transfer step when the binder pattern passes through the second point along with a movement of the transfer belt, instead of transferring the color pattern to the transfer belt.

14. The image forming method according to claim 13, wherein the electric charge application step includes applying a potential having a polarity opposite to a polarity of a potential charged to the binder pattern to a surface on an opposite side of a surface of the transfer belt where the binder pattern has been transferred, and thereby additionally applying electric charge to the binder pattern.

15. The image forming method according to claim 14, wherein the electric charge application step includes additionally applying the electric charge to the binder pattern via a roller which presses the surface on the opposite side of the surface of the transfer belt where the binder pattern has been transferred.

16. The image forming method according to claim 15, wherein the roller is provided at a position opposing a photoreceptor via the transfer belt.

17. The image forming method according to claim 14, wherein the electric charge application step includes applying, when additionally applying the electric charge to the binder pattern, a potential higher than the potential that is applied when the color pattern is transferred to the transfer belt.

18. The image forming method according to claim 13, further comprising
a first secondary transfer step of secondarily transferring the color pattern transferred to the transfer belt in the color pattern transfer step to a release sheet; and
a second secondary transfer step of secondarily transferring the binder pattern to which the electric charge has been applied in the electric charge application step to the color pattern secondarily transferred to the release sheet in the first secondary transfer step.

19. The image forming method according to claim 18, further comprising:
a retracting step of retracting the release sheet to which the color pattern has been secondarily transferred in the first secondary transfer step to a predetermined retracting position when the binder pattern is transferred to the transfer belt in the binder pattern transfer step.

20. The image forming method according to claim 13, wherein the color pattern transfer step includes transferring, as the color pattern, a color pattern in yellow, magenta, or cyan.
